(19) United States
(12) Patent Application Publication
(10) Pub. No.: US 2026/0262061 A1
(43) Pub. Date: Sep. 3, 2026

(54) SUPPORT FOR SIDELINK USER EQUIPMENT IN CO-CHANNEL COEXISTENCE ENVIRONMENTS

(71) Applicant: Nokia Technologies Oy, Espoo (FI)

(72) Inventors: Vinh VAN PHAN, Oulu (FI); Ling YU, Espoo (FI); Nuno Manuel KIILERICH PRATAS, Aalborg (DK); Faranaz SABOURI-SICHANI, Aalborg (DK); Thomas Haaning JACOBSEN, Aalborg (DK); Torsten WILDSCHEK, Gloucester (GB); Daniel MEDINA, Munich (DE); Jari Olavi LINDHOLM, Espoo (FI)

(21) Appl. No.: 18/879,793

(22) PCT Filed: Jul. 28, 2022
(86) PCT No.: PCT/US2022/038648

§ 371 Date: Dec. 29, 2024

(51) Int. Cl. H04W 72/25

(52) U.S. Cl. CPC H04W 72/25

(57) ABSTRACT

Systems, methods, apparatuses, and computer program products for support for sidelink user equipment in co-channel coexistence environments are provided. For example, a method can include configuring a user equipment with a shared resource pool and a sub-resource-pool comprising resources of at least one selected subframe of the shared resource pool for sidelink transmissions according to a first radio access technology in a co-channel coexistence with sidelink transmissions according to a second radio access technology. The method can also include configuring the user equipment with a network configuration for adaptation and use of the sub-resource-pool depending on type of the user equipment.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to support for sidelink user equipment in co-channel coexistence environments.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IOT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus can include at least one processor and at least memory including computer program. The at least one memory and the computer program can be configured to, with the at least one processor, cause the apparatus at least to perform configuring a user equipment with a shared resource pool and a sub-resource-pool comprising resources of at least one selected subframe of the shared resource pool for sidelink transmissions according to a first radio access technology in a co-channel coexistence with sidelink transmissions according to a second radio access technology. The apparatus is also caused to perform configuring the user equipment with a network configuration for adaptation and use of the sub-resource-pool depending on type of the user equipment.

An embodiment may be directed to an apparatus. The apparatus can include at least one processor and at least memory including computer program. The at least one memory and the computer program can be configured to, with the at least one processor, cause the apparatus at least to perform receiving a configuration of a shared resource pool and a sub-resource-pool comprising resources of at least one selected subframe of the shared resource pool for sidelink transmissions according to a first radio access technology in a co-channel coexistence with sidelink transmissions according to a second radio access technology. The apparatus is also caused to perform receiving a network configuration for adaptation and use of the sub-resource-pool depending on type of the user equipment. The apparatus is further caused to perform operating in the sub-resource-pool based on the network configuration.

An embodiment may be directed to a method. The method can include configuring a user equipment with a shared resource pool and a sub-resource-pool comprising resources of at least one selected subframe of the shared resource pool for sidelink transmissions according to a first radio access technology in a co-channel coexistence with sidelink transmissions according to a second radio access technology. The method can also include configuring the user equipment with a network configuration for adaptation and use of the sub-resource-pool depending on type of the user equipment.

An embodiment may be directed to a method. The method can include receiving a configuration of a shared resource pool and a sub-resource-pool comprising resources of at least one selected subframe of the shared resource pool for sidelink transmissions according to a first radio access technology in a co-channel coexistence with sidelink transmissions according to a second radio access technology. The method can also include receiving a network configuration for adaptation and use of the sub-resource-pool depending on type of the user equipment. The method can further include operating in the sub-resource-pool based on the network configuration.

An embodiment can be directed to an apparatus. The apparatus can include means for configuring a user equipment with a shared resource pool and a sub-resource-pool comprising resources of at least one selected subframe of the shared resource pool for sidelink transmissions according to a first radio access technology in a co-channel coexistence with sidelink transmissions according to a second radio access technology. The apparatus can also include means for configuring the user equipment with a network configuration for adaptation and use of the sub-resource-pool depending on type of the user equipment.

An embodiment can be directed to an apparatus. The apparatus can include means for receiving a configuration of a shared resource pool and a sub-resource-pool comprising resources of at least one selected subframe of the shared resource pool for sidelink transmissions according to a first radio access technology in a co-channel coexistence with sidelink transmissions according to a second radio access technology. The apparatus can also include means for receiving a network configuration for adaptation and use of the sub-resource-pool depending on type of the user equipment. The apparatus can further include means for operating in the sub-resource-pool based on the network configuration.

### BRIEF DESCRIPTION OF THE DRAWINGS

For proper understanding of example embodiments, reference should be made to the accompanying drawings, wherein:

FIG. 1 illustrates the spectrum designations in the 5.9 GHz band;

FIG. 2 illustrates spectrum sharing in the 5.9 GHz band in Europe;

FIG. 3A illustrates an example of co-channel co-existence in a same carrier using frequency division multiplexing;

FIG. 3B illustrates an example of co-channel co-existence in a same carrier using time division multiplexing;

FIG. 3C illustrates an example of co-channel co-existence in a same carrier using a mix of time division multiplexing and frequency division multiplexing;

FIG. 3D illustrates an example of co-channel co-existence in a same carrier using overlaid new radio in long term evolution with dedicated new radio resources;

FIG. 3E illustrates an example of co-channel co-existence in a same carrier using overlaid new radio in long term evolution without dedicated new radio resources;

FIG. 4A illustrates mode 3 long term evolution sidelink resource allocation;

FIG. 4B illustrates mode 4 long term evolution sidelink resource allocation;

FIG. 5 illustrates a new radio vehicle to everything subframe slot format for physical sidelink shared channel and physical sidelink control channel;

FIG. 6 illustrates long term evolution vehicle to everything channelization with adjacent and non-adjacent physical sidelink control channel and physical sidelink shared channel;

FIG. 7A illustrates mode 1 new radio sidelink resource allocation;

FIG. 7B illustrates mode 2 new radio sidelink resource allocation;

FIG. 8A illustrates a sidelink slot format of a slot with physical sidelink control channel and physical sidelink shared channel;

FIG. 8B illustrates a sidelink slot format of a slot with physical sidelink control channel and physical sidelink shared channel, as well as physical sidelink feedback channel;

FIG. 9 illustrates physical sidelink shared channel demodulation reference signal configurations based on the number of symbols and duration of the physical sidelink control channel;

FIG. 10 illustrates a sidelink slot with physical sidelink control channel, physical sidelink shared channel, and physical sidelink feedback channel;

FIG. 11 illustrates physical sidelink shared channel to physical sidelink feedback channel mapping;

FIG. 12 illustrates adaptation of sub-resource-pools, according to certain embodiments;

FIG. 13A illustrates a method according to certain embodiments;

FIG. 13B illustrates a further method according to certain embodiments; and

FIG. 14 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing support for sidelink user equipment in co-channel coexistence environments, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to support for new radio (NR) sidelink (SL) user equipment (UE) without long term evolution (LTE) SL capability in co-channel co-existence of LTE and NR SL-based vehicle to everything (V2X). Thus, certain embodiments may relate to Release 18 (Rel-18) sidelink LTE-NR co-channel co-existence.

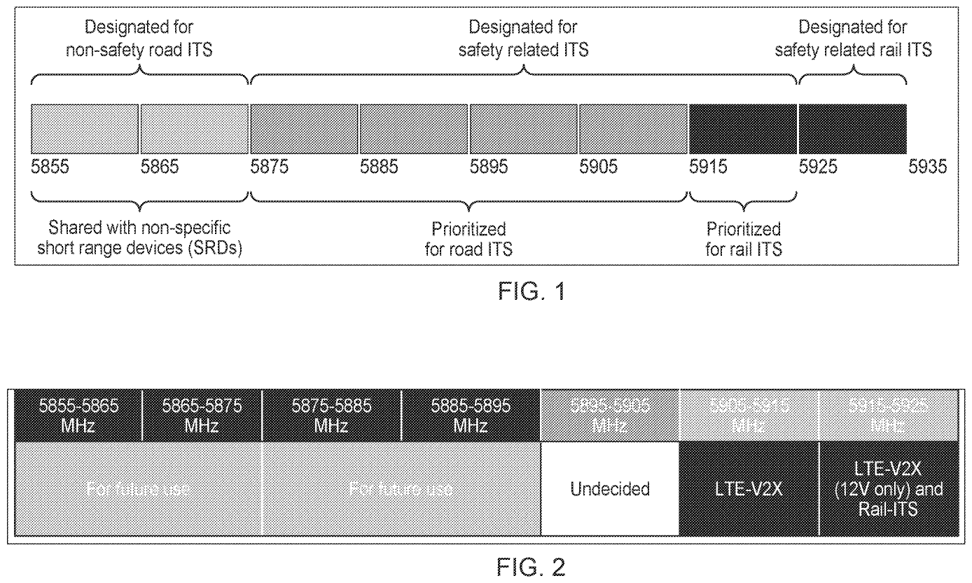

FIG. 1 illustrates the spectrum designations in the 5.9 gigahertz (GHz) band. European administrations have designated the bands 5855-5875 megahertz (MHz) and 5875-5925 MHz, referred to as the 5.9 GHz band, for use by road intelligent transport systems (ITS). LTE-V2X and NR-V2X (C-V2X) technologies may be used for direct communications, via the PC5 interface, in the 5.9 GHz band.

As shown in FIG. 1 different parts of the band may be designated for non-safety road ITS, safety related ITS, and safety related rail ITS. The non-safety road ITS section of the spectrum may be shared with non-specific short range devices (SRDs). By contrast, the spectrum designated for safety related ITS may partly be prioritized for road ITS and partly be prioritized for rail ITS.

In this context, prioritization may imply that no harmful interference is to be caused to the application having priority. Moreover, road-ITS and rail-ITS may remain confined to their respective prioritized frequency range until such time when appropriate spectrum sharing solutions are defined. Furthermore, vehicle-to-vehicle (V2V) communications for road-ITS may only be permitted at 5915-5925 MHz once spectrum sharing solutions for the protection of rail ITS have been developed. In the absence of such sharing solutions for the protection of rail-ITS, infrastructure-to-vehicle (I2V) communications may be permitted for road-ITS at 5915-5925 MHz subject to coordination with rail-ITS. Use of spectrum in the frequency range 5855-5875 MHz may be on a noninterference/non-protected basis, and may include use by non-safety road-ITS and non-specific short range devices.

FIG. 2 illustrates spectrum sharing in the 5.9 GHz band in Europe. As shown in FIG. 2, in the deployment band configuration for C-V2X at 5.9 GHZ in Europe, LTE-V2X may be constrained to the 5905-5915 MHz and 5915-5925 MHz bands. The remaining spectrum may be made available to NR-V2X.

As may be derived from the above, co-channel coexistence between LTE-V 2X and ITS-G5 in the 5.9 GHz band may negatively impact the ability of the technologies to deliver safe and reliable communications, as well as creating further complexities. Accordingly, for the two different types of devices to coexist while using a common carrier frequency, it may be valuable to provide mechanisms to efficiently utilize resource allocation by the two technologies without negatively impacting the operation of each technology.

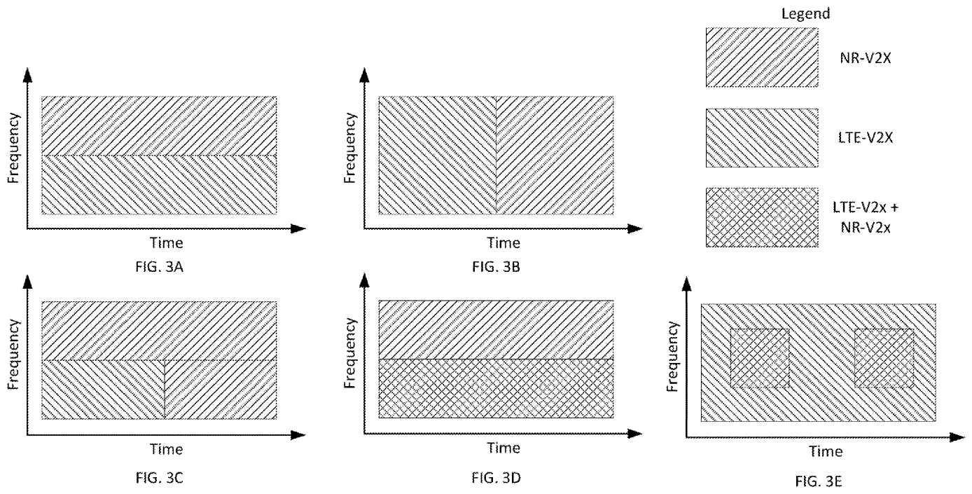

FIGS. 3A-E illustrate examples of co-channel co-existence in a same carrier. FIG. 3A shows frequency division multiplexing (FDM) of LTE-V2X and NR-V2X. FIG. 3B shows time division multiplexing (TDM) of LTE-V2X and NR-V2X. FIG. 3C illustrates a mixture of FDM and TDM of LTE-V2X and NR-V2X. FIG. 3D shows overlaid NR in LTE, with dedicated NR resources, while FIG. 3E illustrates overlaid NR in LTE, without dedicated NR resources. In the approach of FIG. 3E, NR-V2X may access the resources opportunistically.

For the TDM approach illustrated in FIG. 3B, there may need to be synchronization/subframe boundary alignment between LTE and NR. For long term time-scale TDM operation, LTE SL and NR SL resource pools may be configured to not overlap in time domain. For short term time-scale TDM operation, for transmit(TX)/TX overlap and TX/receive(RX) overlap, if packet priorities of both LTE and NR sidelink transmissions/receptions are known to both radio access technologies (RATs) prior to time of transmission subject to processing time restriction, then the packet with a higher relative priority may be transmitted/received. Various prioritizations can be made. For example, the priority of a physical sidelink feedback channel (PSFCH) can be the same as the corresponding physical sidelink shared channel (PSSCH).

By contrast, for the FDM approach illustrated in FIG. 3A there can be static frequency allocation between NR and LTE SL. Synchronization between NR and LTE may not be needed if the frequency separation between NR and LTE is large enough. Power allocation can be static, such that the full UE TX power may be used only when LTE and NR are transmitted simultaneously.

From a resource use point of view, dynamic spectrum sharing, as in the examples depicted in FIG. 3D and FIG. 3E, may be more flexible and may enable higher efficiency. However, these schemes may be more complex due to the ancillary mechanisms that enable their coexistence with other systems. In contrast, static spectrum sharing options, as those depicted in FIGS. 3A, 3B, and 3C may be simpler.

FIG. 3E may be the only available option in practice, because the LTE-V2X devices may be configured to occupy the entire bandwidth and NR-V2X devices may need to be able to adapt to that in order to be able to access the ITS band. Considering potential difficulties of modifying pre-configuration, NR V2X UE may be allowed to use all the available resources, so that there are no dedicated resources for LTE or NR, but the same resources are available for both, which can be viewed as a complete overlap case. In such a case, dynamic spectrum sharing schemes may be the only viable solution for LTE-V2X and NR-V2X coexistence.

Furthermore, the more new vehicles are introduced into the market, the more critical it will become to support advanced V2X use cases that require NR-V2X to operate. At the same time, since CAM (or BSM) can be both sent using LTE-V2X or NR-V2X, then as we progress in time, it is expected that more and more vehicles will utilize NR-V2X and less LTE-V2X. Therefore, by enabling LTE-V2X and NR-V2X to coexist in the same resources, then this will enable a soft re-farming of the LTE-V2X resources. In contrast, if instead static TDM or FDM deployments are considered for LTE-V2X and NR-V2X, this will imply that the resources associated with LTE-V2X will remain allocated potentially for several decades without NR-V2X being able to use those resources. Of course, for this to make sense, NR-V2X will also have to be allowed for safety related ITS.

In the deployment scenario where NR-V2X devices are able to use the same resources, such as the example depicted in FIG. 3D, the NR-V2X numerology may need to be contained as perfectly as possible within the LTE-V2X numerology. NR-V2X may be deployed in frequency range 1 (FR1) with a sub-carrier spacing of 30 kHz, while LTE-V2X may have a sub-carrier spacing of 15 kHz. Therefore, in the time-domain, two NR-V2X slots can be contained in one LTE-V2X subframe, while in the frequency domain, an NR-V2X PRB may have twice the bandwidth of an LTE-V2X physical resource block (PRB). Both LTE-V2X and NR-V2X SL resources may be organized into resource pools, which in the time domain may be organized into slots, in the case of NR-V2X, or subframes, in the case of LTE-V2X, while in the frequency domain these resource pools may be organized into subchannels composed by a number of PRBs.

If LTE-V2X and NR-V2X PRBs are aligned in both time and frequency, then multiple LTE-V2X and NR-V2X resource pools with full overlap can be achieved.

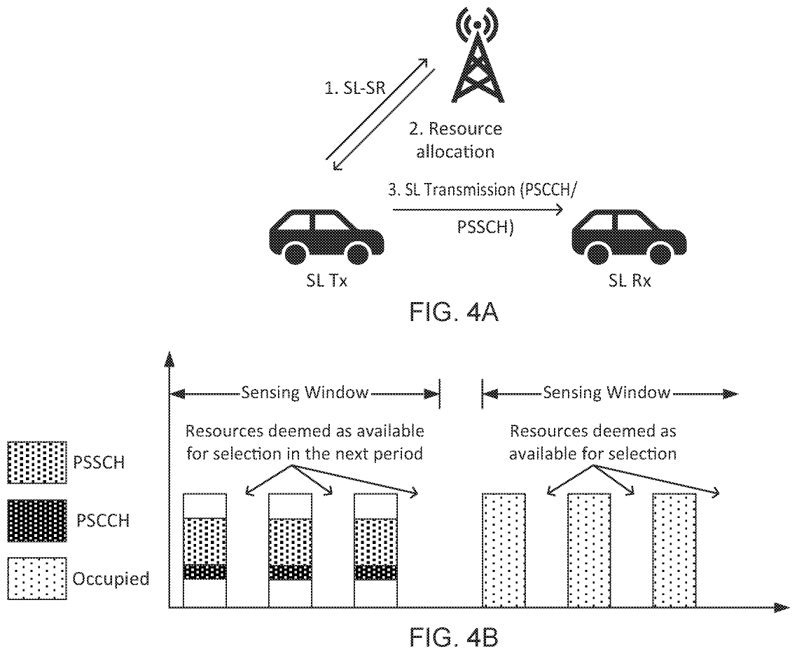

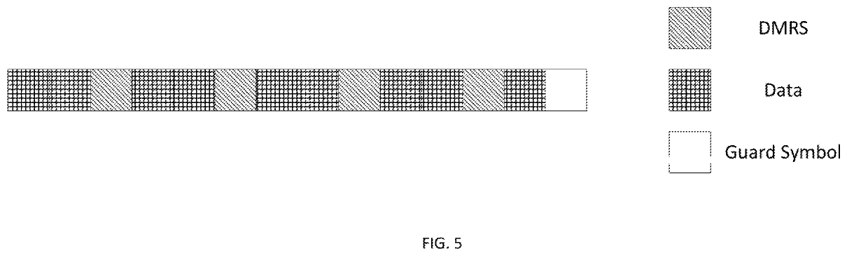

FIGS. 4A and 4B respectively illustrate mode 3 and mode 4 long term evolution sidelink resource allocation. For third generation partnership project (3GPP) release 14 (Rel-14) and release 15 (Rel-15), LTE-V2X has been designed to facilitate vehicles to communicate with other nearby vehicles via direct/SL communication. Communications between these vehicles can take place in LTE-V2X using either mode 3 or mode 4, which are respectively shown in FIGS. 4A and 4B.

As shown in FIG. 4A, when a device is in mode 3, the sidelink radio resources may be scheduled by the base station or evolved NodeB (eNB). Thus, this approach may only be available when vehicles are under cellular coverage.

When in a device is in mode 4 as shown in FIG. 4B, the vehicles may autonomously select their own sidelink radio resources regardless of whether the vehicles are under cellular coverage. When the vehicles are under cellular coverage, the network may decide how to configure the LTE-V2X channel and may inform the vehicles through LTE-V2X configurable parameters. The message can include the carrier frequency of the LTE-V2X channel, the LTE-V2X resource pool, synchronization references, the channelization scheme, the number of subchannels per subframe, and the number of RBs per subchannel, among other things.

When the vehicles are not under cellular coverage, the vehicles can utilize a preconfigured set of parameters to replace the LTE-V2X configurable parameters. The LTE-V2X resource pool may indicate which subframes of a channel are to be utilized for LTE-V2X. The rest of the subframes can be utilized by other services, including cellular communications.

The autonomous resource selection in mode 4 can be performed using a sensing and resource exclusion procedure, for example as specified in Rel-14, in which a vehicle can reserve one or more selected subchannels for a number of periodically recurring packet transmissions. This reservation can, in turn, be sensed by other vehicles, which may affect the resource selection/exclusion decisions of the other vehicles.

FIG. 5 illustrates a long term evolution vehicle to everything subframe slot format for physical sidelink shared channel and physical sidelink control channel. LTE-V2X can use single-carrier FDM access (SC-FDMA) and can support 10 MHz and 20 MHz channels. The channel can be divided into 180 kHz resource blocks (RBs) that correspond to 12 subcarriers of 15 kHz each. In the time domain, the channel can be organized into 1 ms subframes.

Each subframe can have 14 orthogonal FDM (OFDM) symbols with normal cyclic prefix. As shown in FIG. 5, nine of these symbols can be used to transmit data, and four of them, the 3rd, 6th, 9th, and 12th, can be used to transmit demodulation reference signals (DMRSs) for channel estimation and for combating Doppler effect at high speeds. The last symbol can be used as a guard symbol for timing adjustments and for allowing vehicles to switch between transmission and reception across subframes.

The RBs can be grouped into sub-channels. A sub-channel can include RBs only within the same subframe. The number of RBs per sub-channel can vary and can be (pre-)configured. Sub-channels can be used to transmit data and control information. The data can be organized in transport blocks (TBs) that can be carried in the physical sidelink shared channel (PSSCH). A TB can contain a full packet, such as a cooperative awareness message (CAM) or a basic safety message (BSM). A TB can occupy one or several subchannels depending on the size of the packet, the number of RBs per sub-channel, and the utilized modulation and coding scheme (MCS). TBs can be transmitted using quadrature phase shift keying (QPSK), 16 quadrature amplitude modulation (16-QAM) or 64QAM modulations and turbo coding.

Each TB can have an associated sidelink control information (SCI) message that can be carried in the physical sidelink control channel (PSCCH). The message can also be referred to as a scheduling assignment (SA). An SCI can occupy 2 RBs and can include information such as: an indication of the RBs occupied by the associated TB; the MCS used for the TB; the priority of the message that is being transmitted; an indication of whether the message is a first transmission or a blind retransmission of the TB; and the resource reservation interval. A blind retransmission can refer to a scheduled retransmission or repetition of the TB that is not based on feedback from the receiver. The resource reservation interval can specify when the vehicle will utilize the reserved sub-channel(s) to transmit the vehicle's next TB. The SCI can include critical information for the correct reception of the TB. A TB may not be properly decodable if the associated SCI is not received correctly. A TB and the SCI associated with the TB may always be transmitted in the same subframe.

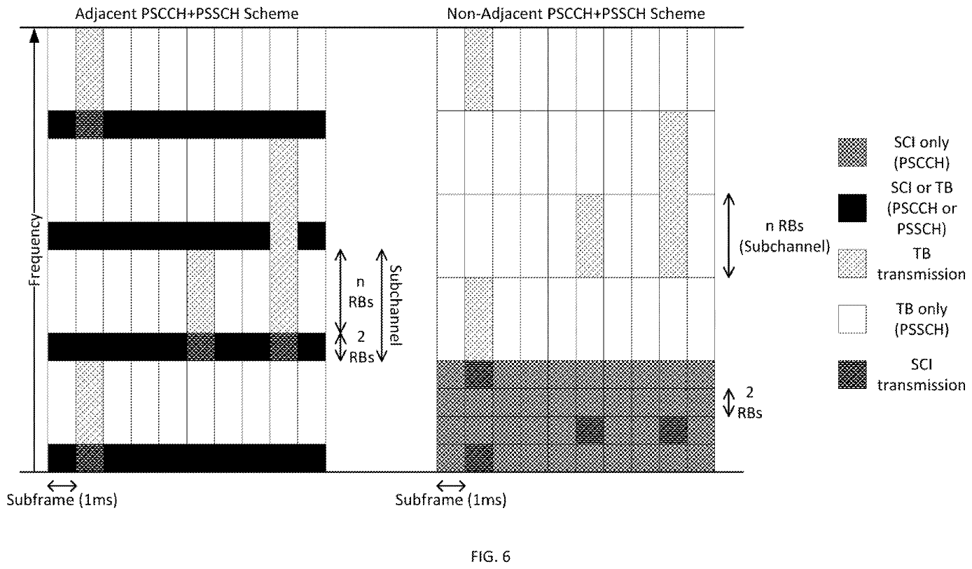

FIG. 6 illustrates long term evolution vehicle to everything channelization with adjacent and non-adjacent physical sidelink control channel and physical sidelink shared channel. As depicted in FIG. 6, the TB, in PSSCH, and the associated SCI, in PSCCH, can be transmitted in adjacent or non-adjacent sub-channels. In the case of adjacent PSCCH and PSSCH shown at the left side of FIG. 6, the SCI and TB can be transmitted in adjacent RBs. For each SCI and TB transmission, the SCI can occupy the first two RBs of the first subchannel utilized for the transmission. The TB can be transmitted in the RBs following the SCI, and can occupy several subchannels, depending on the size of the TB. If the TB occupies several subchannels, the TB can also occupy the first two RBs of the following subchannels.

In the case of non-adjacent PSCCH and PSSCH shown at the right side of FIG. 6, the RBs can be divided into pools. One pool can be dedicated to transmit only SCIs, and the SCIs can occupy two RBs. The second pool can be reserved to transmit only TBs and can be divided into subchannels.

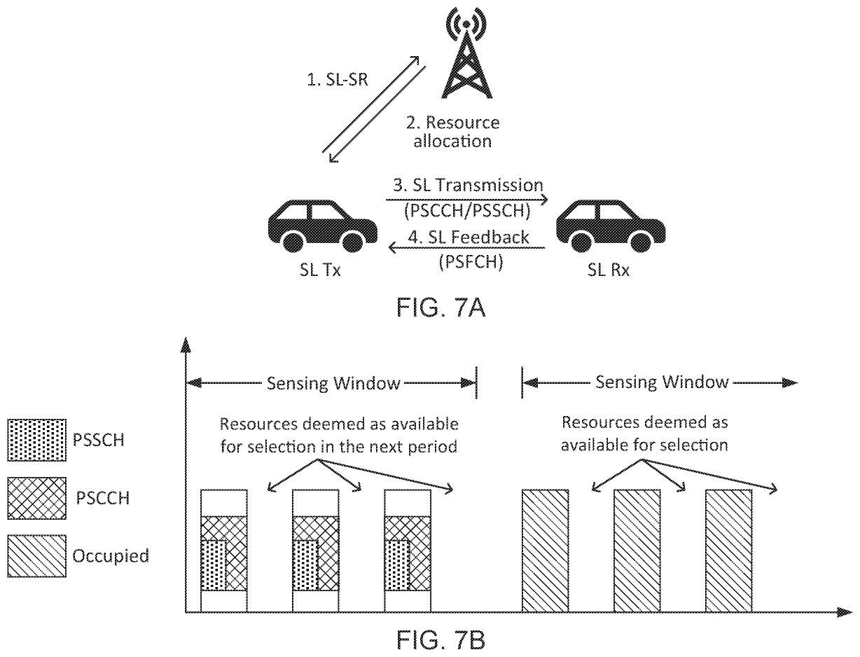

FIGS. 7A and 7B respectively illustrate mode 1 and mode 2 new radio sidelink resource allocation. 3GPP release 16 (Rel-16) designed NR SL to facilitate a user equipment to communicate with other nearby UE(s) via direct/SL communication. Two resource allocation modes have been specified, and a SL transmitter (TX) UE can be configured with one of the two modes to perform that UE's own NR SL transmissions. These modes can be denoted as NR SL mode 1 and NR SL mode 2. In mode 1, a sidelink transmission resource can be assigned or scheduled by the network (NW) to the SL TX UE, while a SL TX UE in mode 2 can autonomously select the UE's SL transmission resources.

In mode 1, in which the gNB may be responsible for the SL resource allocation, the configuration and operation may be similar to the one over the Uu interface, as shown in FIG. 7A. The medium access control (MAC) level details of this procedure can be found at section 5.8.3 of 3GPP technical specification (TS) 38.321.

The SCI can follow a 2-stage SCI structure, whose to support the size difference between the SCIs for various NR-V2X SL service types, such as broadcast, groupcast, and unicast. The 1st-stage SCI, SCI format 1-A, carried by PSCCH, can contain information to enable sensing operations and information for determination of resource allocation of the PSSCH and for decoding 2nd-stage SCI. In Rel-16, the contents of the 1st-stage SCI are specified in 3GPP TS 38.212, section 8.3.1.1. The contents of 2nd stage SCI are also specified in 3GPP TS 38.212, as follows.

The 2nd-stage SCI, SCI format 2-A and 2-B, carried by PSSCH, multiplexed with sidelink shared channel (SL-SCH), can contain source and destination identities, information to identify and decode the associated SL-SCH TB, control of HARQ feedback in unicast/groupcast, and trigger for CSI feedback in unicast.

The configuration of the resources in the sidelink resource pool can define the minimum information required for a RX UE to be able to decode a transmission, which includes the number of sub-channels, the number of PRBs per sub-channels, the number of symbols in the PSCCH, which slots have a PSFCH and other configuration aspects.

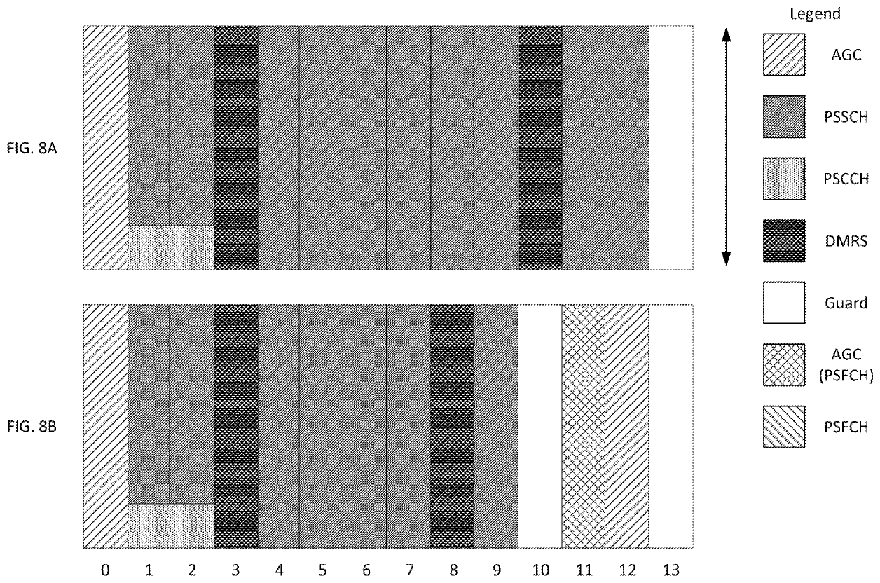

The details of the actual sidelink transmission, such as the payload, can be provided in the PSCCH in 1st-stage SCI for each individual transmission. The details can include the time and frequency resources, the DMRS configuration of the PSSCH, the MCS, and PSFCH, among others. FIGS. 8A and 8B provide examples of the SL slot structure: FIG. 8A shows a slot with PSCCH/PSSCH and FIG. 8B shows a slot with PSCCH/PSSCH where the last symbols can be used for PSFCH.

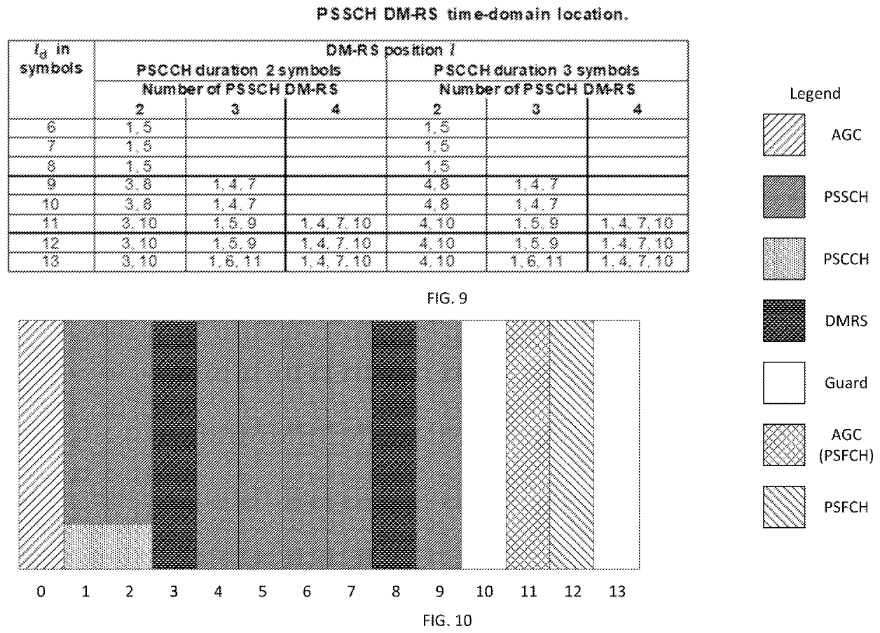

The configuration of the PSCCH, such as demodulation reference signal (DMRS), MCS, and number of symbols used, can be part of the resource pool configuration. Furthermore, the indication of which slots have PSFCH symbols can also be part of the resource pool configuration. However, the configuration of the PSSCH, such as the number of symbols used, the DMRS pattern and the MCS, can be provided by the 1st-stage SCI, which can be the payload sent within the PSCCH and can follow the configuration depicted in FIG. 9. Thus, FIG. 9 illustrates physical sidelink shared channel demodulation reference signal configurations based on the number of symbols and duration of the physical sidelink control channel.

FIG. 10 illustrates a sidelink slot with physical sidelink control channel, physical sidelink shared channel, and physical sidelink feedback channel. The PSFCH was introduced in Rel-16 to enable HARQ feedback over the sidelink from a UE that is the intended recipient of a PSSCH transmission, also referred to as the RX UE, to the UE that performed the transmission, also referred to as the TX UE. Within a PSFCH, a Zadoff-Chu sequence in one PRB can be repeated over two OFDM symbols, the first of which can be used for AGC, near the end of the sidelink resource in a slot. An example slot format of PSCCH, PSSCH, and PSFCH is provided in FIG. 10. The Zadoff-Chu sequence as base sequence is (pre-)configured per sidelink resource pool.

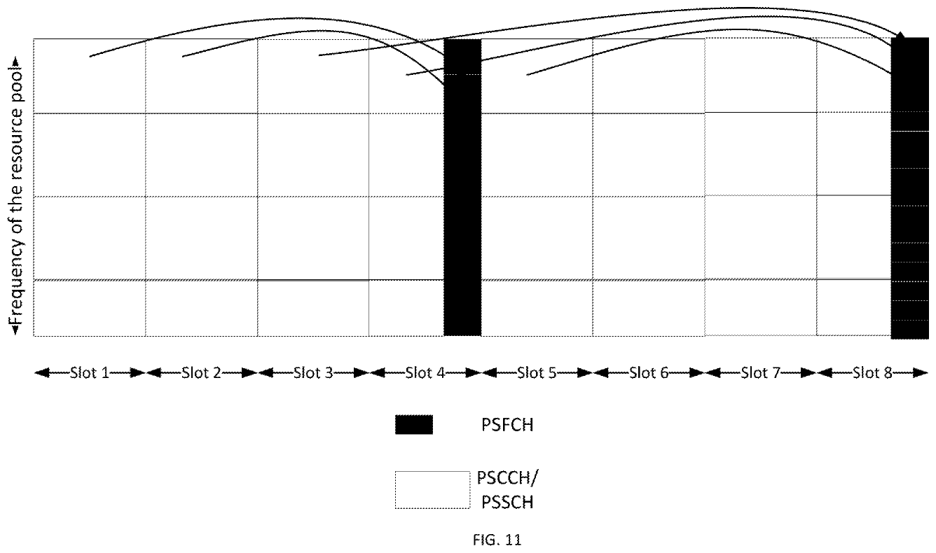

FIG. 11 illustrates physical sidelink shared channel to physical sidelink feedback channel mapping. The time resources for PSFCH are (pre-)configured to occur once every 1, 2, or 4 slots. The HARQ feedback resource (PSFCH) is derived from the resource location of PSCCH/PSSCH.

For PSSCH-to-HARQ timing, there is a configuration parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources. As an example illustrated in FIG. 11, the period of PSFCH resources is configured as 4, and K (the sl-MinTimeGapPSFCH) is configured as 3. For a PSSCH transmitted in slot 1 or 2, the time occasion for the corresponding PSFCH is slot 4. PSFCH resources used for HARQ feedback of PSSCH transmissions with the same starting sub-channel in different slots are frequency division multiplexed (FDMed). As an example shown in FIG. 11, PSFCH resources for PSSCHs in slot 1 and 2 are FDMed in slot 4.

For LTE-NR SL co-channel coexistence (SL Coex), a NR UE operating in NR mode 2 may need to be able to use resources that have been configured as part of a resource pool (RP) for an LTE UE in LTE mode 4. Both NR mode 2 and LTE mode 4 can operate as autonomous resource allocation modes in which a UE is allowed to select and reserve resources from a configured RP for SL transmissions. LTE mode 4 can be based on sensing or random selection, whereas NR mode 2 may be more flexible. NR mode 2 may be based on sensing or random selection, as well as possible pre-emption and inter-UE coordination (IUC).

Shared resources of LTE SL and NR SL in SL Coex may be aligned in time on the basis of SL frame boundaries, and thus LTE SL subframes and NR SL slots. Thus, each LTE subframe may be mapped on 1 NR slot in case an SCS of 15 kHz is applied for both LTE and NR; or each LTE subframe may be mapped on 2 NR slots, referred to as the 1st slot and 2nd slot, in case an SCS of 15 kHz is applied for LTE and 30 kHz for NR, for some examples. NR and LTE SL UEs may access these resources using a RP (LTE RP for LTE SL UEs and NR RP for NR UEs in practice) that overlaps in time and frequency. This RP may be referred to as a shared RP.

3GPP RAN1 may support three types of UE devices in SL Coex, which may be referred to simply for ease of reference, and not by way of preference or priority, as Type-A UE able to use LTE SL and NR SL, Type-B UE able to use NR SL, and Type-C UE able to use LTE SL.

Change to LTE SL may be omitted. Thus, Type-C UE is listed for completeness, as no enhancement on LTE SL for Type-C UE may be made. Type-A UE can be considered as having an LTE SL module and an NR SL module in the same UE and therefore able to transmit and/or receive both LTE SL and NR SL. By contrast, a Type-B UE may be a NR UE able to transmit and/or receive NR SL. Detailed UE capabilities or UE capability categories of Type-A UE and Type-B UE may still be open, and enhancements on NR SL for Type-A UE and Type-B UE may occur. Type-B UE may, for example, have some LTE SL sensing capabilities. Thus, Type-B UE may be further classified into Type-B UE without LTE sensing capabilities, referred to as Type-B1 UE, and Type-B UE with some LTE SL sensing capabilities, referred to as other Type-B UE herein.

Certain embodiments provide a way to enable a Type-B1 UE, which has no LTE SL sensing capability, to use the shared resources. Type-B1 UE without LTE SL sensing capability may not be able to get sufficient knowledge about resource utilization of LTE SL transmissions in the UE's own proximity for the UE perform the UE's own resource selection and reservation. Consequently, the UE may cause collisions to LTE SL transmissions. Efficiency and fairness aspects of the resource sharing may also be taken into consideration.

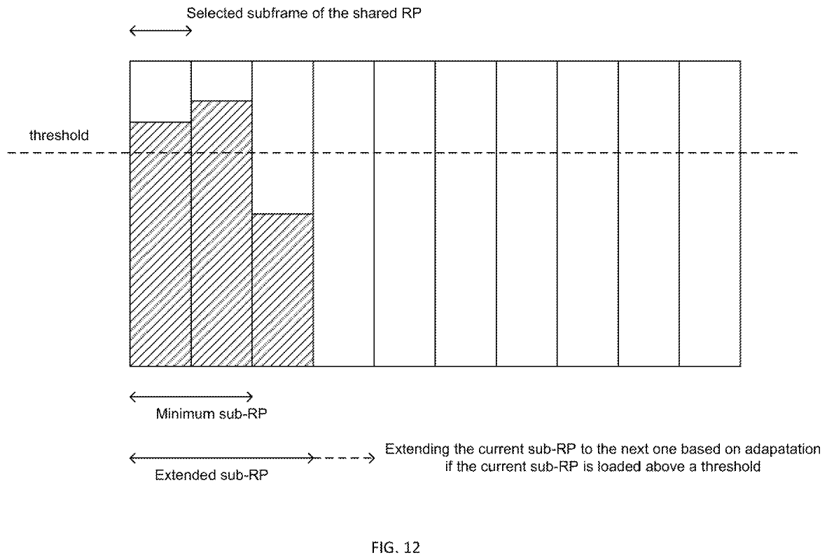

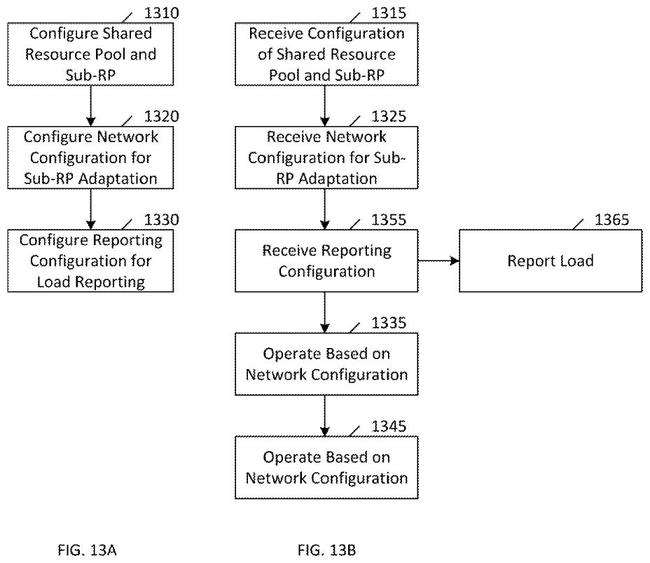

FIG. 12 illustrates adaptation of sub-resource-pools, according to certain embodiments. Certain embodiments may be based on exploring the energy detection specified for the LTE SL sensing as a way to allow fair access for Type-B1 UEs and, at the same time, allowing a gradual resource transition from LTE SL towards NR SL UEs.

The LTE energy detection mechanism may allow an LTE UE to refrain from selecting resources in subframes where the detected energy level is above a predefined threshold. Thus, having NR SL UEs configured to prioritize using resources in a selected subframe of the shared RP in the SL Coex may gradually force LTE SL UEs that are currently using resources in the selected subframe, out of the selected subframe. Such a prioritization can prevent LTE SL UEs from (re)selecting resources in the selected subframe if the occupancy of the selected subframe by NR SL UEs is maintained above a threshold.

To address efficiency and fairness aspects of the resource sharing, the number of such selected subframes and how to allow NR SL UEs including Type-A UEs and Type-B UEs, Type-B UEs including Type-B1 UEs and other Type-B UEs, to use resources in the selected subframes may need to be adaptable. The adaptation may depend on, for example, load of LTE SL UEs and NR SL UEs, load of NR SL UEs including load of Type-A UEs, Type-B1 UEs and other Type-B UEs.

Certain embodiments can provide a method for supporting Type-B1 UE in the SL Coex, which can include configuring NR SL UEs, along with the shared RP, a sub-RP that includes resources of at least one selected subframe of the shared RP together with network configurations that include rules, constraints, conditions or restrictions on how to adapt and use the sub-RP resources for NR SL transmissions, as illustrated for example in FIG. 12.

Network configuration can be realized via, for example system information block (SIB) in common radio resource control (RRC) signaling and dedicated radio resource control (RRC) signaling from a serving gNB to NR SL UEs or pre-configuration to NR SL UEs for out-of-coverage operation. The rules, constraints, conditions or restrictions may include the following.

The sub-RP may be given with a minimum set of selected subframes or a minimum sub-RP and, in addition, one or more extended sets of selected subframes or extended sub-RPs. In one option, an extended set of selected subframes or extended sub-RP can be a superset of all the smaller ones, not just the minimum one. That is, additional selected subframe(s) may be added to the current sub-RP can form a next extended sub-RP, in accordance with the network configurations and based on a predefined order. For example, the UE may start with lower sub-frames and extend incrementally to higher sub-frames as depicted in FIG. 12, for example.

The sub-RP may primarily be used for Type-B1 UEs based on NR SL sensing. Type-B1 UE may use resources of the shared RP outside the sub-pool using other specified method, for example IUC, in which Type-B1 UE may get resource allocation outside the sub-RP from a Type-A UE, or with short-term detection, in which Type-B1 UE may need to detect whether there is LTE transmission in a given subframe in order to decide whether or not to transmit a NR SL transmission in a NR slot within or overlapping with the given subframe, if applicable.

Type-A UEs and other Type-B UEs can be configured to prioritize using resources from the sub-RP in case at least one of the following conditions is met: load of Type-B1 UEs in the sub-RP is below a threshold; load of NR SL UEs in the sub-RP is below a threshold; channel busy ratio (CBR) over the sub-RP is below a threshold; or load of LTE SL UEs over the shared RP is above a threshold. Otherwise, Type-A UEs and other Type-B UEs can be configured to prioritize using resources from the shared RP outside the sub-RP.

The use of these various thresholds may be in order to maintain the occupancy of the sub-RP by NR SL UEs above a threshold to prevent LTE UEs from selecting resources from the sub-RP. Otherwise, Type-A UEs and other Type-B UEs may prioritize resources from the shared RP excluding the sub-RP.

To facilitate load measurement of Type-B1 UEs in the sub-RP, it may be valuable for NR SL UEs to be able to distinguish NR SL transmissions of different types of NR SL UEs or at least Type-B1 from other types. In one option, this differentiation can be realized by having NR SL SCI indicate the type of NR SL UEs, that is, TX UE indicates in its SCI its UE type or at least whether it is a Type-B1 UE or not, at least when operating in the shared pool.

In another option, SL transmissions of Type-B1 UEs in the sub-RP may be allowed to use priority higher than a threshold and SL transmissions of Type-A UEs or other Type-B UEs may use priority equal to or lower than the threshold. In this option, Type-A UEs or other Type-B UEs may prioritize using the sub-RP for SL transmissions with actual priorities lower than the threshold. However, this option may be most valuable when SL transmissions of Type-B1 UEs are expected to have high priorities.

In light of the sub-RP configuration for possible adaptation, the rules, constraints, conditions or restrictions may include additional aspects. For example, the next extended sub-RP can be determined, for example adapted from the current sub-RP and taken into use, by a given Type-B1 UE if at least one of the following conditions is met, in accordance with the network configurations: there are no available resources in the current sub-RP with possible use of preemption for the given Type-B1 UE; CBR over the current sub-RP is above a threshold; load of NR SL UEs in the current sub-RP is above a threshold; load of NR SL Type-B1 UEs in the current sub-RP is above a threshold; CBR over the shared RP including or excluding the current sub-RP is below a threshold; load of NR SL UEs over the shared RP including or excluding the current sub-RP is below a threshold.

To enhance the chance for Type-B1 UE to get access to the sub-RP, Type-B1 UE may be allowed to pre-empt reserved resources of Type-A UEs or other Type-B UEs in the sub-RP even if the priority of Type-A UE or other Type-B UE is equal to or somewhat higher, for example within limited constraints, than that of Type-B1 UE.

The next extended sub-RP may be determined, for example adapted from the current sub-RP and taken into use, by a given Type-A UE or other Type-B UE if at least one of the following conditions is met, in accordance with the network configurations: CBR over the current sub-RP is above a threshold; load of NR SL UEs in the current sub-RP is above a threshold; load of NR SL Type-B1 UEs in the current sub-RP is above a threshold; CBR over the shared RP including or excluding the current sub-RP is below a threshold; load of NR SL UEs over the shared RP including or excluding the current sub-RP is below a threshold; or load of LTE SL UEs is below a threshold.

The conditions and thresholds mentioned above may be configured to vary from the current sub-RP to the next extended sub-RP or from one selected subframe to another selected subframe along with the adaptation, according to the network configurations. Thresholds configured for Type-A UE or other Type-B UE may be the same as or different from corresponding thresholds configured for Type-B1 UE for the sub-RP adaptation.

Type-A UE and other Type-B UE with some LTE sensing capabilities may be able to detect the presence of LTE SL UEs, measure load of LTE SL UEs, as well as indicate or share such the information with Type-B1 UEs via NR SL signaling such as NR SL SCI or IUC information. This may be used to enhance the adaptation of the sub-pool for Type-B1 UEs or, that is, conditions related to load or presence of LTE SL UEs may also be applied for Type-B1 UEs. For example, the condition that the load of LTE SL UEs is below a threshold can be applied for Type-B1 UE if Type-B1 gets up-to-date LTE SL load information from Type-A UE or other Type-B UE.

To further synchronize the adaptation of the sub-RP among NR SL UEs in proximity, NR SL UEs may indicate the index of the current sub-RP, which may be represented by, for example, the index of the last or highest subframe or slot of the sub-RP in SCI. Type-B1 UE may determine to synchronize the current sub-RP to one of those indicated by Type-A UEs in proximity for example. Further synchronization can be left up to Type-B1 UE or specified by the network configurations such that a Type-B1 UE may opt for the smallest sub-RP among those with the indexes indicated by Type-A UEs or other NR SL UEs in proximity or for the largest one.

NR SL UEs, at least Type-A and other Type-B UEs, may be configured to report LTE load to gNB and based on that gNB may reconfigure the sub-RP and related network configurations.

For a possible support of legacy NR SL UEs (Rel-16 and Rel-17 NR SL UEs) in SL Coex, the minimum sub-RP may be configured to legacy NR SL UEs as a regular Tx RP. Because legacy NR SL UEs are not able to adapt the sub-RP for an efficient and fair resource sharing, the serving network or gNB may need to perform reconfiguration of the minimum sub-RP or permission (enable-disable) for legacy NR SL UEs to use the minimum sub-RP more often, depending on load of legacy NR SL UEs in addition to loads of LTE SL UEs, Type-A and Type-B NR SL UEs. Thus, Type-A and Type-B UEs may be configured to detect and report about the presence and load of legacy NR SL UEs over the minimum sub-RP to the gNB.

Type-A and other Type-B SL UEs may transmit an NR SL reservation that overlaps a detected LTE high priority transmission on the sub-RP. In this way, the high priority LTE SL transmissions may also be protected in the sub-RP.

Certain embodiments can involve configuring part of the shared LTE-NR V2x resource pool, denoted here as a sub-RP, for NR type B1 UEs. In certain embodiments, an indication about the type of NR SL UEs related to its capability as type A, B, B1 as discussed above can provided in NR SL SCI, for example when operating in the shared pool.

Optionally, in certain embodiments a UE may report determined LTE load to gNB, for example by SL NR type A and type B UEs. Type-A and Type-B UEs may be additionally configured to detect and report about the presence and load of legacy NR SL UEs over the minimum sub-RP to the gNB.

Certain embodiments may allow NR SL signaling like NR SL SCI or IUC to be used by Type-A UE, or type B UE with capability to detect LTE, to detect the presence of LTE SL UEs, measure load of LTE SL UEs as well, and share such the information with Type-B1 UEs directly or indirectly.

FIG. 13A illustrates a method according to certain embodiments. As shown in FIG. 13A, a method can include, at 1310, configuring a user equipment with a shared resource pool and a sub-resource-pool comprising resources of at least one selected subframe of the shared resource pool for sidelink transmissions according to a first radio access technology in a co-channel coexistence with sidelink transmissions according to a second radio access technology, for example, for sidelink transmissions according to a first radio access technology (NR) in a co-channel coexistence with sidelink transmissions according to a second radio access technology (LTE). Sidelink transmission according to the first radio access technology can be on the basis of a slot within a subframe and sidelink transmission according to the second radio access technology can be on the basis of a subframe. The method can also include, at 1320, configuring the user equipment with a network configuration for adaptation and use of the sub-resource-pool depending on type of the user equipment.

LTE uses the term subframe, while NR uses slot in a similar way. As used herein, the two expressions can be understood interchangeably. The shared resource pool can include resources shared between sidelink communications according to the first RAT and the second RAT and resources of selected subframes can be used for sidelink transmission according to either the first RAT or the second RAT.

The type of the user equipment can be one of a first type that has no capability of receiving sidelink transmissions according to the second radio access technology and a second type that has capability of receiving sidelink transmissions according to the second radio access technology.

The network configuration can be provided to the user equipment in common radio resource control signaling such as system information block or in dedicated radio resource control signaling. The network configuration can be pre-configured to the user equipment for out-of-coverage operation of the user equipment.

The network configuration can include a minimum set of selected subframes or a minimum sub-resource-pool and one or more extended set of selected subframes or extended sub-resource-pools.

The one or more extended set of selected subframes or the extended sub-resource pools can be a superset of the minimum set of selected subframes or the minimum sub-resource-pool.

The network configuration can provide a usage order of the one or more extended set of selected subframes or the extended sub-resource pools. The network configuration can indicate that the user equipment is to use a next extended sub-resource pool upon at least one of the following conditions being met, in accordance with the network configuration: there are no available resources in a current sub-resource-pool for sidelink transmissions of the user equipment; channel busy ratio over a current sub-resource-pool is above a threshold; load of sidelink transmissions according to the first radio access technology in a current sub-resource pool is above a threshold; load of sidelink transmissions from user equipment of the first type in a current sub-resource-pool is above a threshold; channel busy ratio over the shared resource pool including or excluding a current sub-resource-pool is below a threshold; load of sidelink transmissions according to the first radio access technology over the shared resource pool including or excluding a current sub-resource-pool is below a threshold; or load of sidelink transmissions according to the second radio access technology over the shared resource pool including or excluding a current sub-resource-pool is below a threshold.

The user equipment may be of a first type or a second type, where the first type can be Type-B1, which may have no capability for sidelink communications according to the second radio access technology and the second type can be Type-A and other Type-B, which may have capability for sidelink communications according to the second radio access technology.

The network configuration can indicate that the user equipment in case the user equipment is of the second type is to prioritize using resources from the sub-resource-pool when at least one of the following conditions is met or otherwise to prioritize using resources outsides the sub-resource-pool: load of sidelink transmissions from user equipment of the first type in the sub-resource-pool is below a threshold; load of sidelink transmissions according to the first radio access technology in the sub-resource-pool is below a threshold; a channel busy ratio over the sub-resource-pool is below a threshold; or load of sidelink transmissions according to the second radio access technology over the shared resource pool including or excluding the sub-resource-pool is above a threshold.

The network configuration can indicate that the user equipment, in case the user equipment is of the first type, is to prioritize using resources from the sub-resource-pool according to the first radio access technology.

The network configuration can indicate that the user equipment in case the user equipment is of the first type has permission to preempt other user equipment of the second type over resources from the sub-resource-pool conditioned on a priority of the other user equipment of the second type being greater than a priority of the user equipment by less than a threshold amount.

Certain embodiments may apply for Type-B1 UE over Type-A UE and other Type-B UE. These can be various sidelink configuration types. The use of the sub-RP can be dependent on the type of the UE. The sub-RP can be configured for Type-B1 UE primarily such that: Type-B1 UE can use the sub-RP according to the first RAT; and Type-B1 UE can be allowed to pre-empt resources of Type-A UE and other Type-B UE with relaxed conditions compared to that specified in the current NR, for example in case the priority of Type-B1 UE is equal to or lower than that of Type-A or other Type-B UE to certain extent, lower but within a limit.

The network configuration can include dynamic thresholds that vary from a current sub-resource-pool to a next sub-resource-pool or from one selected subframe to another selected subframe.

The method can also include, at 1330, configuring the user equipment with a reporting configuration to report load in the shared resource pool, the sub-resource-pool, or both the shared resource pool and the sub-resource pool.

FIG. 13B illustrates a method according to certain embodiments. The method of FIG. 13B can be used in combination with the method of FIG. 13A. As shown in FIG. 13B, a method can include, at 1315, receiving a configuration of a shared resource pool and a sub-resource-pool comprising resources of at least one selected subframe of the shared resource pool for sidelink transmissions according to a first radio access technology in a co-channel coexistence with sidelink transmissions according to a second radio access technology. Sidelink transmission according to the first radio access technology can be on the basis of a slot within a subframe and sidelink transmission according to the second radio access technology can be on the basis of a subframe. The method can also include, at 1325, receiving a network configuration for adaptation and use of the sub-resource-pool depending on type of the user equipment. The type of the user equipment can be one of a first type that has no capability of receiving sidelink transmissions according to the second radio access technology and a second type that has capability of receiving sidelink transmissions according to the second radio access technology. The method can further include, at 1335, operating in the sub-resource-pool based on the network configuration.

The network configuration can be received in common radio resource control signaling such as system information block or in dedicated radio resource control signaling. The network configuration is pre-configured to the user equipment for out-of-coverage operation of the user equipment.

The network configuration can include a minimum set of selected subframes or a minimum sub-resource-pool and one or more extended set of selected subframes or extended sub-resource-pools.

The one or more extended set of selected subframes or the extended sub-resource pools can be a superset of the minimum set of selected subframes or the minimum sub-resource-pool.

The network configuration can provide a usage order of the one or more extended set of selected subframes or the extended sub-resource pools.

The network configuration can indicate that the user equipment is to use a next extended sub-resource pool upon at least one of the following conditions being met, in accordance with the network configuration: there are no available resources in a current sub-resource-pool for sidelink transmissions of the user equipment; channel busy ratio over a current sub-resource-pool is above a threshold; load of sidelink transmissions according to the first radio access technology in a current sub-resource pool is above a threshold; load sidelink transmissions from user equipment of the first type in a current sub-resource-pool is above a threshold; channel busy ratio over the shared resource pool including or excluding a current sub-resource-pool is below a threshold; load of sidelink transmissions according to the first radio access technology over the shared resource pool including or excluding a current sub-resource-pool is below a threshold; or load of sidelink transmissions according to the second radio access technology over the shared resource pool including or excluding a current sub-resource-pool is below a threshold.

The network configuration can indicate that the user equipment in case the user equipment is of the second type is to prioritize using resources from the sub-resource-pool when at least one of the following conditions is met or otherwise to prioritize using resources outsides the sub-resource-pool: load of sidelink transmissions from user equipment of the first type in the sub-resource-pool is below a threshold; load of sidelink transmissions according to the first radio access technology in the sub-resource-pool is below a threshold; a channel busy ratio over the sub-resource-pool is below a threshold; or load of sidelink transmissions according to the second radio access technology over the shared resource pool including or excluding the sub-resource-pool is above a threshold.

The method can also include, at 1345, providing the type of the user equipment in sidelink control information. The method can further include, at 1355, receiving a reporting configuration to report load in the shared resource pool, the sub-resource-pool, or both the shared resource pool and the sub-resource pool. The method can further include, at 1365, reporting the load based on the reporting configuration.

The network configuration can indicate that the user equipment, in case the user equipment is of the first type, is to prioritize using resources from the sub-resource-pool according to the first radio access technology.

The network configuration can indicate that the user equipment in case the user equipment is of the first type has permission to preempt other user equipment of the second type over resources from the sub-resource-pool conditioned on a priority of the other user equipment of the second type being greater than a priority of the user equipment by less than a threshold amount.

The network configuration can include dynamic thresholds that vary from a current sub-resource-pool to a next sub-resource-pool or from one selected subframe to another selected subframe.

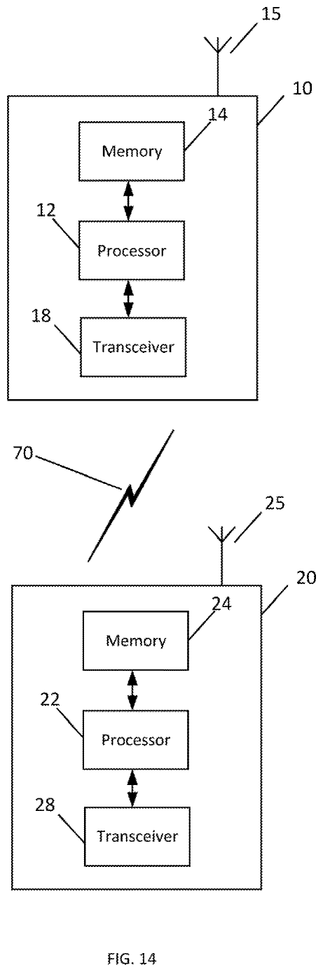

FIG. 14 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 14.

As illustrated in the example of FIG. 14, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 14, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to support for sidelink user equipment in co-channel coexistence environments.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 12, 13A, and 13B, or any other method described herein. In some embodiments, as discussed herein, apparatus 10 may be configured to perform a procedure relating to providing support for sidelink user equipment in co-channel coexistence environments, for example.

FIG. 14 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 14.

As illustrated in the example of FIG. 14, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 14, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 12, 13A, and 13B, or any other method described herein. For example, in an embodiment, apparatus 20 may be controlled to perform a process relating to providing support for sidelink user equipment in co-channel coexistence environments, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may allow improved co-channel co-existence between LTE-V2X SL and NR-V2X SL with different types of NR SL UEs such as with or without LTE SL capability. Such improved co-existence may lead to greater spectral efficiency and a minimization of unnecessary collisions.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium. The term “non-transitory” as used herein, is a limitation of the medium itself (i.e. tangible, not a signal) as opposed to a limitation on data storage persistency (e.g. RAM vs. ROM).

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### Partial Glossary

AGC Automatic Gain Control
BSM Basic Safety Message
CAM Cooperative Awareness Message
DMRS DeModulation Reference Signal
HARQ Hybrid Automatic Repeat Request
ITS Intelligent Transport Systems
MCS Modulation and Coding Scheme
OFDM Orthogonal Frequency Division Multiplex
PRB Physical Resource Block
PSCCH Physical Sidelink Control Channel
PSFCH Physical Sidelink Feedback Channel
PSSCH Physical Sidelink Shared Channel
QAM Quadrature Amplitude Modulation
QPSK Quadrature Phase Shift Keying
RP Resource Pool
RSRP Reference Signal Received Power
RX Receiver
SA Scheduling Assignment
SCI Sidelink Control Information
SC-FDMA Single-Carrier Frequency-Division Multiple Access
SPS Semi Persistent Scheduling
TB Transport Block
TX Transmitter
V2X Vehicle-to-Everything

1-74. (canceled)

75. An apparatus, comprising:
at least one processor; and
at least one memory storing instructions that, when executed by the at least one processor, cause the apparatus at least to:
configure a user equipment with a shared resource pool and a sub-resource-pool comprising resources of at least one selected subframe of the shared resource pool for sidelink transmissions according to a first radio access technology in a co-channel coexistence with sidelink transmissions according to a second radio access technology; and
configure the user equipment with a network configuration for adaptation and use of the sub-resource-pool depending on type of the user equipment.

76. The apparatus according to claim 75, wherein sidelink transmission according to the first radio access technology is on the basis of a slot within a subframe and sidelink transmission according to the second radio access technology is on the basis of a subframe.

77. The apparatus according to claim 75, wherein the type of the user equipment is one of a first type which has no capability of receiving sidelink transmissions according to the second radio access technology and a second type which has capability of receiving sidelink transmissions according to the second radio access technology.

78. The apparatus according to claim 75, wherein the network configuration comprises a minimum set of selected subframes or a minimum sub-resource-pool and one or more extended set of selected subframes or extended sub-resource-pools.

79. The apparatus according to claim 78, wherein the one or more extended set of selected subframes or the extended sub-resource pools are a superset of the minimum set of selected subframes or the minimum sub-resource-pool.

80. The apparatus according to claim 75, wherein the network configuration indicates that the user equipment in case the user equipment is of the second type is to prioritize using resources from the sub-resource-pool when at least one of the following conditions is met or otherwise to prioritize using resources outsides the sub-resource-pool:
load of sidelink transmissions from user equipment of the first type in the sub-resource-pool is below a threshold;
load of sidelink transmissions according to the first radio access technology in the sub-resource-pool is below a threshold;
a channel busy ratio over the sub-resource-pool is below a threshold; or
load of sidelink transmissions according to the second radio access technology over the shared resource pool including or excluding the sub-resource-pool is above a threshold.

81. The apparatus according to claim 75, wherein the network configuration indicates that the user equipment in case the user equipment is of the first type is to prioritize using resources from the sub-resource-pool according to the first radio access technology.

82. The apparatus according to claim 75, wherein the network configuration indicates that the user equipment in case the user equipment is of the first type has permission to preempt other user equipment of the second type over resources from the sub-resource-pool conditioned on a priority of the other user equipment of the second type being greater than a priority of the user equipment by less than a threshold amount.

83. The apparatus according to claim 75, wherein the network configuration comprises dynamic thresholds that vary from a current sub-resource-pool to a next sub-resource-pool or from one selected subframe to another selected subframe.

84. The apparatus according to claim 75, wherein the instructions, when executed by the at least one processor, further cause the apparatus to:
configure the user equipment with a reporting configuration to report load in the shared resource pool, the sub-resource-pool, or both the shared resource pool and the sub-resource pool.

85. An apparatus, comprising:
at least one processor; and
at least one memory storing instructions that, when executed by the at least one processor, cause the apparatus, at a user equipment, at least to:
receive a configuration of a shared resource pool and a sub-resource-pool comprising resources of at least one selected subframe of the shared resource pool for sidelink transmissions according to a first radio access technology in a co-channel coexistence with sidelink transmissions according to a second radio access technology;
receive a network configuration for adaptation and use of the sub-resource-pool depending on type of the user equipment; and
operate in the sub-resource-pool based on the network configuration.

86. The apparatus according to claim 85, wherein the network configuration is pre-configured to the user equipment for out-of-coverage operation of the user equipment.

87. The apparatus according to claim 85, wherein the network configuration comprises a minimum set of selected subframes or a minimum sub-resource-pool and one or more extended set of selected subframes or extended sub-resource-pools.

88. The apparatus according to claim 87, wherein the one or more extended set of selected subframes or the extended sub-resource pools are a superset of the minimum set of selected subframes or the minimum sub-resource-pool.

89. The apparatus according to claim 87, wherein the network configuration provides a usage order of the one or more extended set of selected subframes or the extended sub-resource pools.

90. The apparatus according to claim 89, wherein the network configuration indicates that the user equipment is to use a next extended sub-resource pool upon at least one of the following conditions being met, in accordance with the network configuration:
there are no available resources in a current sub-resource-pool for sidelink transmission of the user equipment;
channel busy ratio over a current sub-resource-pool is above a threshold;
load of sidelink transmissions according to the first radio access technology in a current sub-resource pool is above a threshold;
load of sidelink transmissions from user equipment of the first type in a current sub-resource-pool is above a threshold;
channel busy ratio over the shared resource pool including or excluding a current sub-resource-pool is below a threshold;
load of sidelink transmissions according to the first radio access technology over the shared resource pool including or excluding a current sub-resource-pool is below a threshold; or
load of sidelink transmissions according to the second radio access technology over the shared resource pool including or excluding a current sub-resource-pool is below a threshold.

91. The apparatus according to claim 85, wherein the network configuration indicates that the user equipment in case the user equipment is of the second type is to prioritize using resources from the sub-resource-pool when at least one of the following conditions is met or otherwise to prioritize using resources outsides the sub-resource-pool:
load of sidelink transmissions from user equipment of the first type in the sub-resource-pool is below a threshold;
load of sidelink transmissions according to the first radio access technology in the sub-resource-pool is below a threshold;
a channel busy ratio over the sub-resource-pool is below a threshold; or
load of sidelink transmissions according to the second radio access technology over the shared resource pool including or excluding the sub-resource-pool is above a threshold.

92. The apparatus according to claim 85, wherein the instructions, when executed by the at least one processor, further cause the apparatus to:
provide the type of the user equipment in sidelink control information.

93. The apparatus according to claim 85, wherein the instructions, when executed by the at least one processor, further cause the apparatus to:
receive a reporting configuration to report load in the shared resource pool, the sub-resource-pool, or both the shared resource pool and the sub-resource pool; and
report the load based on the reporting configuration.

94. A method, comprising:
receiving a configuration of a shared resource pool and a sub-resource-pool comprising resources of at least one selected subframe of the shared resource pool for sidelink transmissions according to a first radio access technology in a co-channel coexistence with sidelink transmissions according to a second radio access technology;
receiving a network configuration for adaptation and use of the sub-resource-pool depending on type of the user equipment; and
operating in the sub-resource-pool based on the network configuration.
